(19) United States
(12) Patent Application Publication
(10) Pub. No.: US 2023/0351986 A1
(43) Pub. Date: Nov. 2, 2023

(54) MUSIC PLAYING METHOD

(71) Applicant: NEC Corporation, Minato-ku, Tokyo (JP)

(72) Inventors: Sayaka TOHARA, Tokyo (JP); Takuya SERA, Tokyo (JP); Noboru YOSHIDA, Tokyo (JP)

(73) Assignee: NEC Corporation, Minato-ku, Tokyo (JP)

(21) Appl. No.: 17/800,635

(22) PCT Filed: Mar. 17, 2020
(86) PCT No.: PCT/JP2020/011762

§ 371 Date: Aug. 18, 2022

(51) Int. Cl. G10H 1/00; G06T 7/73

(52) U.S. Cl. CPC G10H 1/0008; G06T 7/74; G06T 2207/30196; G10H 2220/455

(57) ABSTRACT

A music playing device 100 of the present invention includes an acquisition means 121 for acquiring a plurality of feature points of a person from a captured image in which the person is captured, a detection means 122 for detecting a position relationship between a plurality of the feature points in a feature point set in which the plurality of feature points are combined, and an output means 123 for outputting a sound specified based on the detected position relationship.

### TECHNICAL FIELD

The present invention relates to a music playing method, a music playing device, and a program.

### BACKGROUND ART

Playing musical instruments such as a guitar, a violin, and a trumpet is not easy, and it often takes time to practice. Moreover, for children, elderly persons, and disabled persons, there is a case where it is difficult to play musical instruments because of physical reasons. However, a person who is difficult to play musical instruments also has a desire to play musical instruments for interest and entertainment.

Patent Literature 1 discloses art that enables outputting of a musical instrument sound without actually playing a musical instrument. Specifically, the art of Patent Literature 1 extracts a skin color portion such as a hand or an arm of a user from a captured image of the user, analyzes the optical flow of such a skin color portion, and outputs a sound of a musical instrument according to the orientation and the magnitude of the optical flow.
Patent Literature 1: JP 2018-49052 A
Non-Patent Literature 1: Yadong Pan et & Shoji Nishimura, “Multi-Person Pose Estimation with Mid-Points for Human Detection under Real-World Surveillance”, The 5th Asian Conference on Pattern Recognition (ACPR 2019), 26-29 Nov. 2019

### SUMMARY

However, in the art of Patent Literature 1, since a sound of a musical instrument is output based on the optical flow of a body part such as a hand or an arm of a user, some users may be difficult to perform operation because of a physical reason. As a result, there is a problem that users who can use it may be limited.

In view of the above, an object of the present invention is to provide a music playing method, a music playing device, and a program capable of solving the problem described above, that is, a problem that in a system that can output a sound without actually playing a musical instrument, users who can use it may be limited.

A music playing method according to one aspect of the present invention is configured to include
acquiring a plurality of feature points of a person from a captured image in which the person is captured;
detecting a position relationship between a plurality of the feature points in a feature point set in which the plurality of feature points are combined; and
outputting a sound specified based on the detected position relationship.

Further, a music playing device according to one aspect of the present invention is configured to include
an acquisition means for acquiring a plurality of feature points of a person from a captured image in which the person is captured;
a detection means for detecting a position relationship between a plurality of the feature points in a feature point set in which the plurality of feature points are combined; and
an output means for outputting a sound specified based on the detected position relationship.

Further, a program according to one aspect of the present invention is configured to cause an information processing device to realize
an acquisition means for acquiring a plurality of feature points of a person from a captured image in which the person is captured;
a detection means for detecting a position relationship between a plurality of the feature points in a feature point set in which the plurality of feature points are combined; and
an output means for outputting a sound specified based on the detected position relationship.

With the configurations described above, the present invention can suppress limitation of users who can use a system that can output a sound without actually playing a musical instrument.

### BRIEF DESCRIPTION OF DRAWINGS

FIG. 1 is a block diagram illustrating the overall configuration of a music playing system according to a first exemplary embodiment of the present invention.

FIG. 2 is a block diagram illustrating a configuration of a music playing device disclosed in FIG. 1.

FIG. 3 illustrates a state of processing by the music playing device disclosed in FIG. 1.

FIG. 4 illustrates a state of processing by the music playing device disclosed in FIG. 1.

FIG. 5 illustrates a state of processing by the music playing device disclosed in FIG. 1.

FIG. 6 illustrates a state of processing by the music playing device disclosed in FIG. 1.

FIG. 7 illustrates a state of processing by the music playing device disclosed in FIG. 1.

FIG. 8 illustrates a state of processing by the music playing device disclosed in FIG. 1.

FIG. 9 is a flowchart illustrating an operation of the music playing device disclosed in FIG. 1.

FIG. 10 illustrates a state of another type of processing by the music playing device disclosed in FIG. 1.

FIG. 11 illustrates a state of another type of processing by the music playing device disclosed in FIG. 1.

FIG. 12 is a block diagram illustrating a hardware configuration of a music playing device according to a second exemplary embodiment of the present invention.

FIG. 13 is a block diagram illustrating a configuration of the music playing device according to the second exemplary embodiment of the present invention.

FIG. 14 is a flowchart illustrating an operation of the music playing device according to the second exemplary embodiment of the present invention.

### EXEMPLARY EMBODIMENTS

### First Exemplary Embodiment

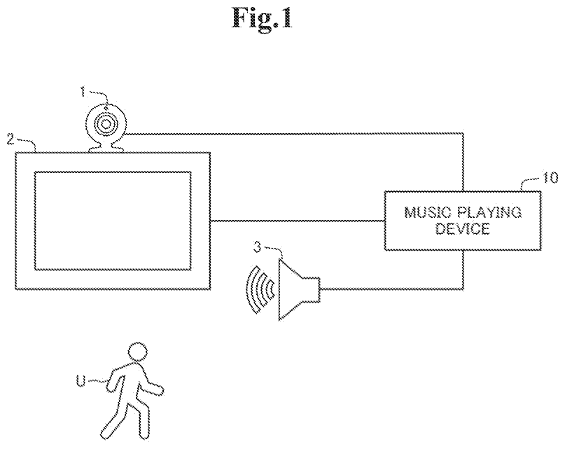

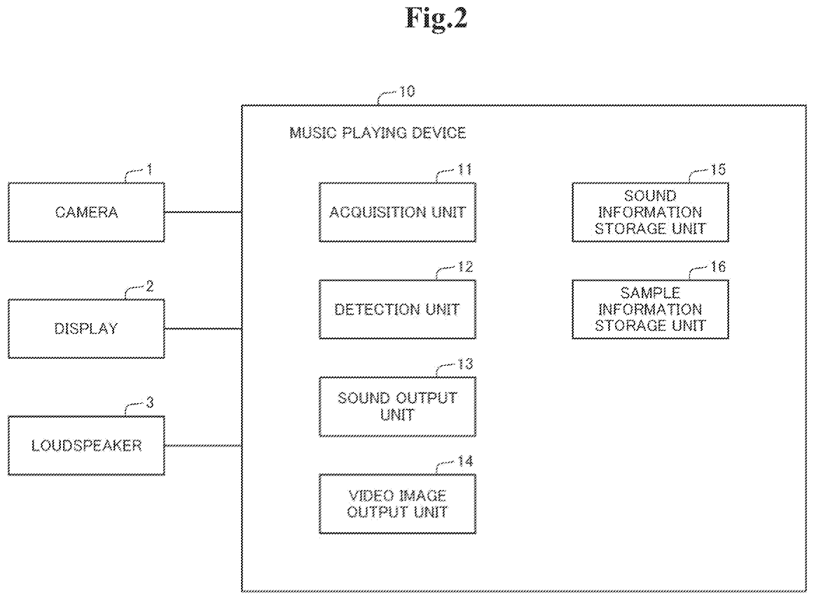

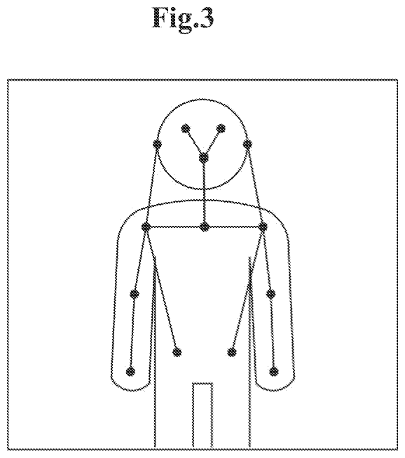

A first exemplary embodiment of the present invention will be described with reference to FIGS. 1 to 11. FIGS. 1 and 2 are diagrams for explaining a configuration of a music playing system and a music playing device, and FIGS. 3 to 11 are illustrations for explaining the processing operation of the music playing device.

[Configuration]

A music playing system of the present embodiment is a system for enabling a sound to be output without actually playing a musical instrument by a user U. A music playing system is installed in, for example, an event site, and when the user U attending the event performs a predetermined operation, the system operates to output a sound without playing a musical instrument. However, the music playing system may be installed in any place, and the user U may be any person. For example, the target user U may be a child. an elderly person, or a disabled person, and the music playing system may be installed in any facility such as a dancing school, a gymnastic school, or a rehabilitation facility. That is, the music playing system may be used not only for the purpose of simply playing a musical instrument by the user U but for the purpose of moving a body as described below.

As illustrated in FIG. 1, the music playing system is configured to include a camera 1, a display 2, a loudspeaker 3, and a music playing device 10. The camera 1 is an imaging device that images the user U who uses the music playing system. For example, the camera 1 continuously images the user U, and transmits the captured images to the music playing device 10. The display 2 is a display device that outputs video images. The display outputs captured images in which the user U is captured by the camera 1, or a prepared sample image (image information) serving as a sample of operation, for example. The loudspeaker 3 is a sound output device that outputs sound such as a musical instrument sound. The loudspeaker 3 outputs sound according to the operation of the user U, for example.

The music playing device 10 is configured of one or a plurality of information processing devices each having an arithmetic device and a storage device. As illustrated in FIG. 2, the music playing device 10 includes an acquisition unit 11, a detection unit 12, a sound output unit 13, and a video image output unit 14. The respective functions of the acquisition unit 11, the detection unit 12, the sound output unit 13, and the video image output unit 14 can be realized through execution, by the arithmetic unit, of a program for realizing the respective functions stored in the storage device. Further, the music playing device 10 includes a sound information storage unit 15 and a sample information storage unit 16. Each of the sound information storage unit 15 and the sample information storage unit 16 is configured of a storage device. The music playing device 10 is connected with the camera 1, the display 2, and the loudspeaker 3. Hereinafter, the respective constituent elements will be described in detail.

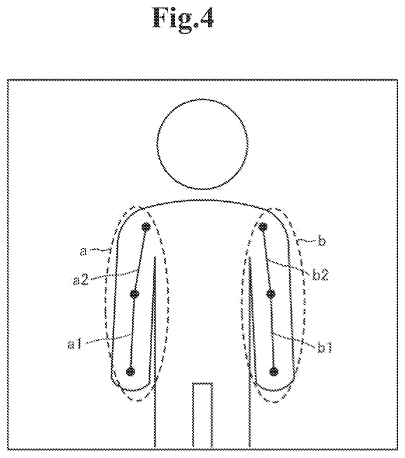

The acquisition unit 11 (acquisition means) acquires a captured image captured by the camera 1. Then, the acquisition unit 11 detects the user U shown in the captured image, and acquires a plurality of feature points of the user U having been set. Specifically, the acquisition unit 11 uses a posture estimation technique as described in Non-Patent Literature 1 to extract joint positions and body part positions of the user U as feature points, and acquires position information of a specific feature point among them. For example, as illustrated in FIG. 3, the acquisition unit 11 acquires position information of a wrist, an elbow, a shoulder, an a pelvis that are joint positions of the user, and position information of an eye, a nose, and an ear that are body part positions of the user. Then, as illustrated in FIG. 4 in particular, the acquisition unit 11 of the present embodiment acquires position information of a combination of three feature points such as a wrist, an elbow, and a shoulder of a right arm as a first feature point set “a”, and position information of a combination of three feature points such as a wrist, an elbow, and a shoulder of a left arm as a second feature point set “b”.

However, the acquisition unit 11 may extract any feature points of the user U and may use a combination of any feature points as a feature point set. For example, the acquisition unit 11 may use a combination of a plurality of feature points of body parts such as an ankle, a knee, and a hip of the lower half of a body as a feature point set. Further, the acquisition unit 11 may use a combination of a joint position and other body part positions such as an eye and a nose as a feature point set, without limiting to using a combination of feature points of a plurality of joint positions as a feature point set. Further, the acquisition unit 11 may extract feature points by using any technique, not necessarily limiting to extracting feature points of the user U by using the posture estimation technique described above. Note that the number of feature points constituting a feature point set is not limited to three, and may be two or four or more.

The detection unit 12 (detection means) detects a position relationship among the feature points constituting a feature point set acquired from the user U. In the present embodiment, as illustrated in FIG. 4, the detection unit 12 detects a position relationship of the first feature point set “a” in which three feature points such as a wrist, an elbow, and a shoulder of a right arm are combined, and a position relationship of the second feature point set “b” in which three feature points such as a wrist, an elbow, and a shoulder of a left arm are combined. Specifically, the detection unit 12 first detects, in the first feature point set “a”, a position relationship of the feature point set “a” on the basis of a shape of each of line segments linking feature points, such as a first line segment a1 linking the wrist and the elbow, and a second line segment a2 linking the elbow and the shoulder. At that time, as the position relationship of the first feature point set “a”, the detection unit 12 detects an angle defined by the first line segment a1 and the second line segment a2, and the orientations of the first line segment a1 and the second line segment a2, and determines a previously set position relationship to which such a position relationship corresponds. Similarly, regarding the second feature point set “b”, the detection unit 12 detects a position relationship of the second feature point set “b” on the basis of the shape of each of line segments linking feature points, such as a first line segment b1 linking the wrist and the elbow, and a second line segment b2 linking the elbow and the shoulder.

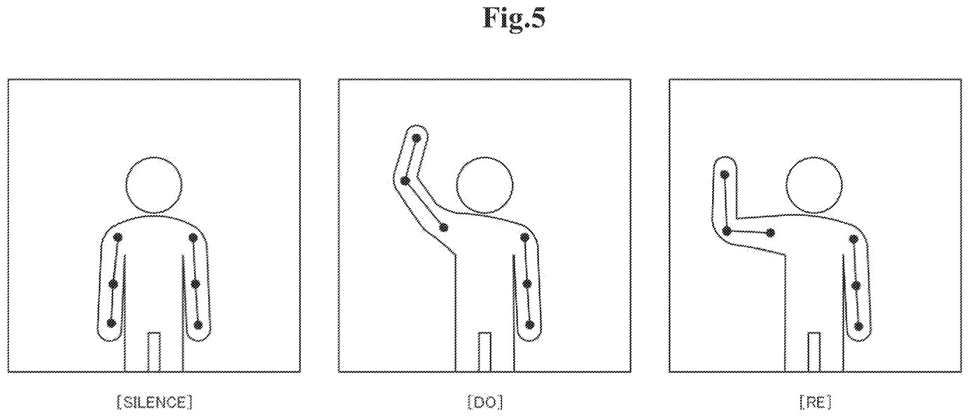

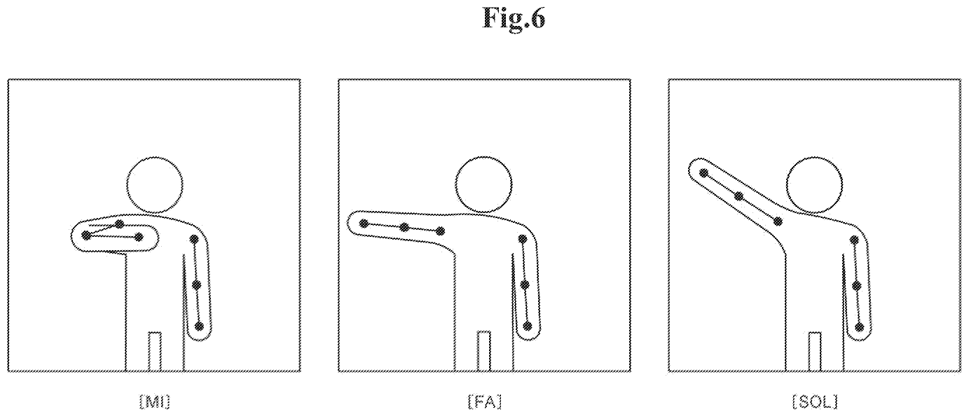

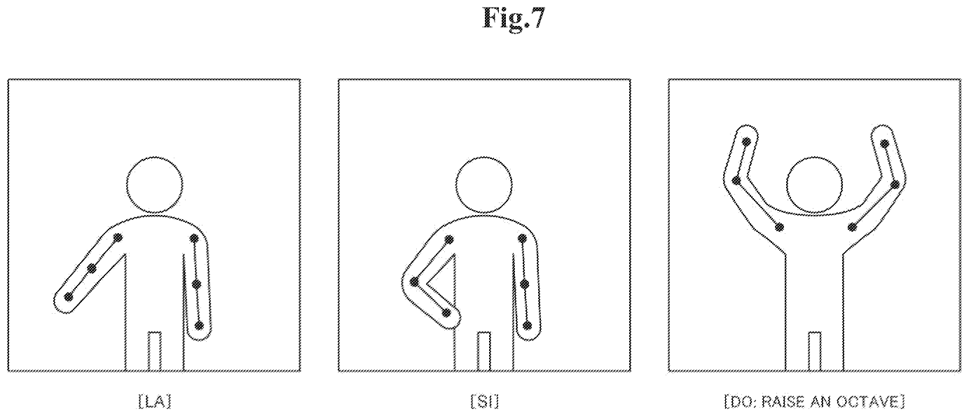

Examples of previously set position relationships are illustrated in FIGS. 5 to 7. Note that the position relationships that are previously set for the first feature point set “a” of a right arm are associated with notes in the musical scale, respectively. For example, the position relationship illustrated in the left drawing of FIG. 5 is associated with “silence”, the position relationship illustrated in the center drawing of FIG. 5 is associated with a note “Do” in the scale, and the position relationship illustrated in the right drawing of FIG. 5 is associated with a note “Re” in the scale. Further, the position relationship illustrated in the left drawing of FIG. 6 is associated with a note “Mi” in the scale, the position relationship illustrated in the center drawing of FIG. 6 is associated with a note “Fa” in the scale, and the position relationship illustrated in the right drawing of FIG. 6 is associated with a note “Sol” in the scale. Further, the position relationship illustrated in the left drawing of FIG. 7 is associated with a note “La” in the scale, and the position relationship illustrated in the center drawing of FIG. 7 is associated with a note “Si” in the scale.

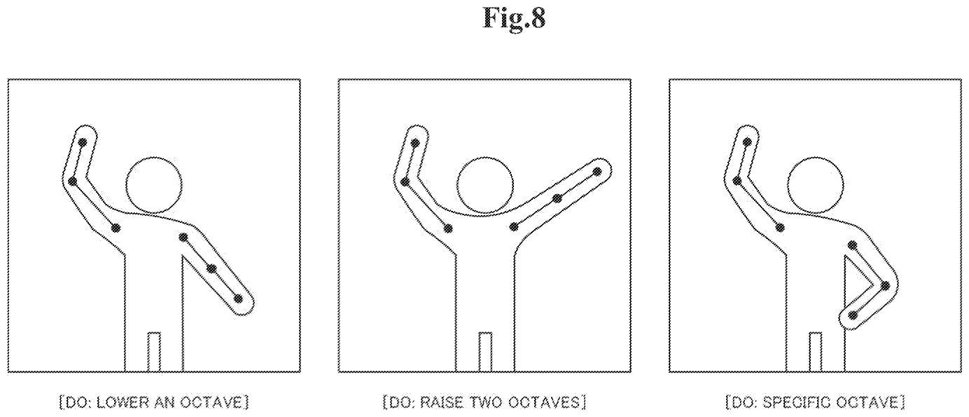

Further, the position relationships that are previously set for the second feature point set “b” of a left arm are associated with commands to operate an octave, respectively. For example, the position relationship illustrated in the center drawing of FIG. 5. is associated with the “standard octave”. Accordingly, one musical note can be specified from a combination of the position relationship of the first feature point set “a” and the position relationship of the second feature point set “b”. In the examples from FIG. 5 to the center drawing of FIG. 7, the “standard octave” is designated from the position relationship of the second feature point set “b” of the left arm. Therefore, from the position relationship of the first feature point set “a” of the right arm, it is possible to specify one note of the “Do, Re, Mi, Fa, Sol, La, Si” in the “standard octave”. Further, regarding the second feature point set “b”, the position relationship illustrated in the right drawing of FIG. 7 is associated with “raise an octave”. Accordingly, in the right drawing of FIG. 7, “one octave higher” from the previous octave is designated, and from the position relationship of the first feature point set “a” of the right arm, a note “Do” in one octave higher that is designated from the position relationship of the first feature point set “a” of the right arm is specified. As similar to the above description, regarding the second feature point set “b”, the position relationship illustrated in the left drawing of FIG. 8 is associated with “lower the octave”, the position relationship illustrated in the center drawing of FIG. 8 is associated with “raise two octaves”, and the position relationship illustrated in the right drawing of FIG. 8 is associated with a “specific octave”.

Here, when the detection unit 12 detects position relationships of the respective feature point sets “a” and “b”, the detection unit 12 determines a previously set position relationship to which the position relationship actually detected from the user U corresponds. At that time, the detection unit 12 selects a previously set position relationship that is determined to be the same as the position relationship detected from the user U, according to a predetermined reference. That is, the detection unit 12 sets a similarity range for each of the previously set position relationships, and when the position relationship detected from the user U is included in such a similarity range, the detection unit 12 determines that they are the same according to the predetermined reference. Therefore, the detection unit 12 does not require the position relationships of the feature point sets “a” and “b” to be completely the same as any of the preset position relationships. The detection unit 12 determines that those having an angle defined by a first line segment (a1 or b1) and a second line segment (a2 or b2) or the orientations of the first line segment (a1 or b1) and the second line segment (a2 or b2) are determined to be the same within the predetermined range, have the same position relationship.

Note that the detection unit 12 may detect the position relationships of the respective feature point sets “a” and “b” by any method, without being limited to the detection based on the shape linking the feature points as described above. For example, the detection unit 12 may specify the position relationships of the respective feature point sets “a” and “b” from the position relationships of coordinates of the respective feature points. Further, while the detection unit 12 detects the respective position relationships of the two feature point sets “a” and “b”, the detection unit 12 may detect position relationships of one or three or more feature point sets.

Further, in the above description, the detection unit 12 specifies a note in the musical scale by the position relationship of the first feature point set “a”, specifies an octave by the position relationship of the second feature point set “b”, and consequently specifies one note from the combination of the position relationships of the feature point sets “a” and “b”. However, another note may be specified by the position relationship of the first feature point set “a” or the position relationship of the second feature point set “b”. For example, the position relationship of the second feature point set “b” may be associated with the type of a musical instrument. The position relationship of the second feature point set “b” may specify a musical instrument, and the position relationship of the first feature point set “a” may specify the scale of the musical instrument. Further, the detection unit 12 is not limited to specify one note from a combination of the position relationships of the plurality of feature point sets “a” and “b”, and may specify a note for each position relationship of each feature point set. Further, the detection unit 12 is not necessarily limited to specify a single note by the position relationship of a feature point set, but may specify any sound such as a chord in which a plurality of notes sound simultaneously.

The sound output unit 13 (output means) outputs the sound specified based on the position relationships of the feature point sets “a” and “b” as described above, from the loudspeaker 3. At that time, the sound output unit 13 acquires sound source data corresponding to the sound specified based on the position relationships of the feature point sets “a” and “b” from the sound source data stored in the sound information storage unit 15, and plays such sound data to thereby output the sound from the loudspeaker 3. Note that when one sound is specified from a combination of the position relationship of the feature point sets “a” and “b”, the sound output means outputs the sound thereof, while when different sounds are specified from the position relationships of the feature point sets “a” and “b” respectively, the sound output means outputs the sounds simultaneously, or sequentially outputs the sounds at time intervals.

The video image output unit 14 (output means) outputs the captured image captured by the camera 1 so as to directly display it on the display 2. At that time, the video image output unit 14 may display the captured image, and also display information representing the position relationships of the feature point sets “a” and “b” of the user U detected by the detection unit 12 by adding it on the captured image. For example, as illustrated in FIG. 5 and elsewhere, the video image output unit 14 may display the feature points constituting the feature point sets “a” and “b” extracted from the user U and the line segments linking the respective feature points while superimposing them on the position of the user U on the captured image.

Further, the video image output unit 14 may output sample information configured of images showing a sample of a position relationship of a feature point set, stored in the sample information storage unit 16, to display it on the display 2. At that time, the video image output unit 14 may output a plurality of pieces of sample information on the display 2 or output sample information of a position relationship of a feature point set corresponding to the sound that is requested to be output currently.

Note that the sound output unit 13 may first output a sound of the sound source data from the loudspeaker 3 and request the user U to take a posture of the position relationship of the feature point set corresponding to such sound. In association with it, the video image output unit 14 may output, on the display 2, sample information of the position relationship of the feature points corresponding to the sound output by the sound output unit 13. Further, when the sound output unit 13 first plays the sound source data and outputs a sound or the video image output unit 14 first displays sample information, it is possible to determine whether a position relationship that is the same as the position relationship of the feature point set corresponding to such sound source data or such sample information is detected from the user U by the detection unit 12, and display the determination result on the display 2.

[Operation]

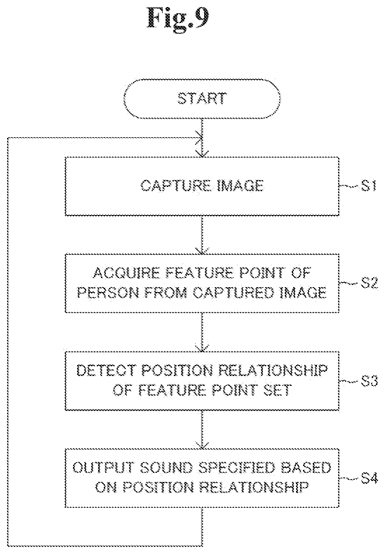

Next, operation of the music playing device 10 described above will be described with mainly reference to the flowchart of FIG. 9. The music playing device 10 acquires a captured image captured by the camera 1. At that time, the music playing device 10 may output the captured image captured by the camera 1 to directly display it on the display 2. The music playing device 10 may previously output a sound of sound source data from the loudspeaker 3, or output sample information of a position relationship of a feature point set to display it on the display 2. Thereby, the user U can refer to the video image of himself/herself shown on the display 2, the previously output sound, or the sample information of the position relationship of the feature point set. and act to take a posture to output the sound.

Then, the music playing device 10 detects the user U shown in the captured image, and acquires a plurality of predetermined feature points of the user U (step S2). For example, as illustrated in FIG. 4, the music playing device 10 acquires position information of a combination of three feature points such as a wrist, an elbow, and a shoulder of the right arm as the first feature point set “a”, and position information of a combination of three feature points such as a wrist, an elbow, and a shoulder of the left arm as the second feature point set “b”. Note that the music playing device 10 may extract any feature points of the user U, and may use a combination of any feature points as a feature point set.

Then, the music playing device 10 detects a position relationship of the acquired feature point set configured of a plurality of feature points (step S3). For example, as illustrated in FIG. 4, the music playing device 10 detects a position relationship of the first feature point set “a” in which three feature points such as a wrist, an elbow, and a shoulder of the right arm are combined, and a position relationship of the second feature point set “b” in which three feature points such as a wrist, an elbow, and a shoulder of the left arm are combined. Then, the music playing device 10 determines a previously set position relationship to which the position relationship of each of the feature point sets “a” and “b” detected from the user U corresponds. That is, the device determines to which of the position relationships illustrated in FIGS. 5 to 8, the position relationship of each of the feature point sets “a” and “b” detected from the user U corresponds.

Then, the music playing device 10 specifies a sound from the position relationship of each of the detected feature point sets, and outputs the sound from the loudspeaker 3 (step S4). Specifically, the music playing device 10 specifies an octave from the position relationship of the second feature point set “b” of the left arm, and specifies a note in the musical scale from the position relationship of the first feature point set “a” of the right arm, and outputs the sound of the finally specified note from the loudspeaker 3. At that time, the music playing device 10 specifies and outputs one note from a combination of position relationships of a plurality of the feature point sets. However, the music playing device 10 may specify a note from each position relationship of a plurality of feature point sets, and outputs a plurality of specified notes. The music playing device 10 may output the position relationship of a feature point set detected from the user U as described above to display it on the display 2.

<Modifications>

Next, modifications of the music playing device 10 of the present embodiment will be described. In the above description, the music playing device 10 specifies a sound to be output based on the position relationship of a feature point set of the user U. However, the music playing device 10 may specify a sound to be output based on the information of the user U. Therefore, the music playing device 10 may have a configuration as described below.

The acquisition unit 11 extracts the user U shown in the captured image captured by the camera 1, and detects information of the user U. For example, from the appearance of the user U, the acquisition unit 11 detects information about attributes such as gender, age group, height (high or low), and the type of clothes (comfortable outfit, uncomfortable outfit), and the standing position of the user U in the captured image. That is, the acquisition unit 11 also has a function as a user information detection unit that detects information such as attributes and characteristics of the user. As an example, the acquisition unit 11 specifies a part of the face from a face image of the user U and detects the gender and age group from the characteristics of the face part, or specifies the size in the height direction and the position of the user with respect to the captured image and detects information such as the height and the standing position from such information. However, the information of the user U may be any information, and detection of such information may be performed by any method.

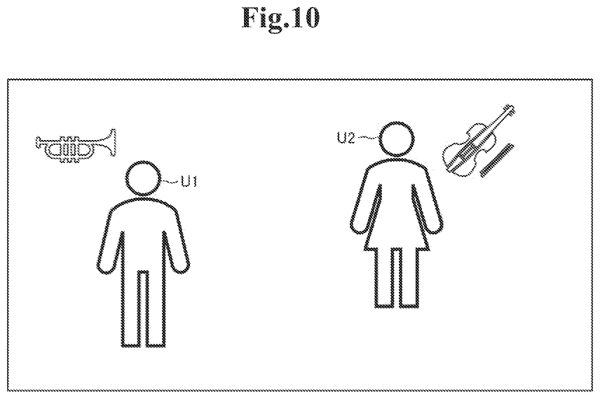

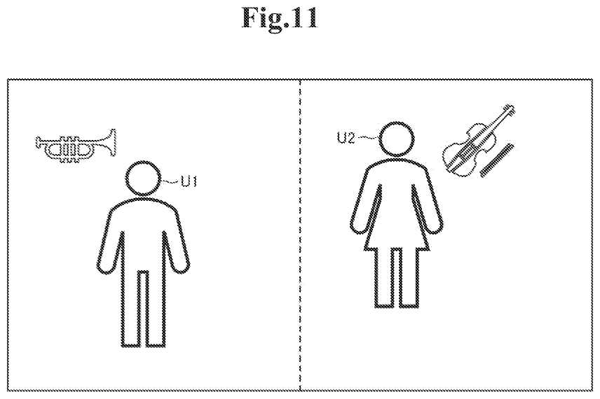

When there are a plurality of users U in the captured image, the acquisition unit 11 extracts each of the users U, and extracts information such as attributes for each user U. For example, as illustrated in FIG. 10, when there are two users U1 and U2 in the captured image, the acquisition unit 11 detects that the attribute of the user U1 on the left side is male and the attribute of the user U2 on the right side is female. alternatively, as illustrated in FIG. 11, when there are two users U1 and U2 in the captured image, the acquisition unit 11 detects the standing positions of the users U1 and U2, that is, the user U1 is located in the left-side area and the user U2 is located in the right-side area.

Then, as similar to the above description, the acquisition unit 11 acquires a feature point set configured of a plurality of feature points of the user U. At that time, when the acquisition unit 11 extracts a plurality of users U1 and U2, the acquisition unit 11 acquires a feature point set for each of the users U1 and U2. Note that while the examples of FIGS. 10 and 11 illustrate the case where there are two users U in the captured image, even in the case where there are three or more users U, the acquisition unit 11 detects information of each of the users U as described above and acquires a feature point set.

The detection unit 12 detects, for each of the users U1 and U2 detected as described above, the position relationship of each feature point set of each of the users U1 and U2. Then, for each of the users U1 and U2, the detection unit 12 specifies a sound to be output by using the information of the users U1 and U2 detected as described above and the position relationship of the feature point set of each of the users U1 and U2. For example, the detection unit 12 specifies a musical instrument by the gender of each of the users U1 and U2 and specifies the sound of the musical instrument by the position relationship of the feature point set of the user U. For example, in the example of FIG. 10, since the user U1 on the left side is male, a trumpet that is a musical instrument previously set to the gender of male is specified, and since the user U2 on the right side is female, a violin that is a musical instrument previously set to the gender of female is specified. Further, in the example of FIG. 11, since the standing position of the user U1 is a left side, a trumpet that is a musical instrument previously set to such a standing position is specified, and since the standing position of the user U2 is a right side, a violin that is a musical instrument previously set to such a standing position is specified. Then, the detection unit 12 specifies the sound of each musical instrument on the basis of the position relationship of the feature point set detected from each of the users U1 and U2.

While the case of changing the musical instrument according to the information of the users U1 and U2 has been described above, the detection unit 12 may change another element of specifying the sound to be output. For example, the octave may be changed according to the information of the users U1 and U2. Further, the detection unit 12 may change the degree of difficulty of outputting the sound according to the information of the users U1 and U2. For example, while the detection unit 12 specifies the sound of each musical instrument on the basis of a position relationship of a feature point set detected from each of the users U1 and U2, the detection unit 12 may change the reference for determining that the position relationship detected from the user U and the previously set position relationship are the same, according to the information from the users U1 and U2. As an example, when detecting that a user is a child, the detection unit 12 may set the previously set similarity range of the position relationship to be wider compared with the case of detecting that a user is an adult so as to allow the position relationship detected from the user U to be determined to be the same as any of the previously set position relationships, to thereby lower the degree of difficulty of outputting the sound.

The sound output unit 13 outputs a specified sound from the loudspeaker 3 as described above. For example, when it is specified that the musical instrument is a trumpet, the sound output unit 13 uses the sound source data of a trumpet and outputs the sound specified from the position relationship of the feature point set. At that time, the user U may be allowed to move freely, without displaying sample information to the user U as described above. Then, the sound output unit 13 may output a sound specified from the information of the user U who is moving freely and the position relationship of the feature point set by the acquisition unit 11 and the detection unit 12. Further, the sound output unit 13 may generate a musical score of the output sound or record the sound.

As described above, according to the music playing device and the music playing method of the present embodiment, it is possible to detect position relationships of a plurality of feature point sets acquired from a captured image of a person, and output a sound specified based on such position relationships. Therefore, even in the case where an operation similar to the operation of playing a musical instrument is difficult because of a physical reason for children, elderly persons, and disabled persons, it is possible to output a sound by an easy operation. Further, even in the situation where an optical flow of a body part such as a hand or an arm of a user cannot be detected due to the clothes of the user or imaging conditions (imaging environment, frame rate, or the like), it is possible to output a sound easily. As a result, in a system that allows a sound to be output without actually playing a musical instrument, the system can be used by any user, and it is possible to improve entertainment and to use it for various purposes.

### Second Exemplary Embodiment

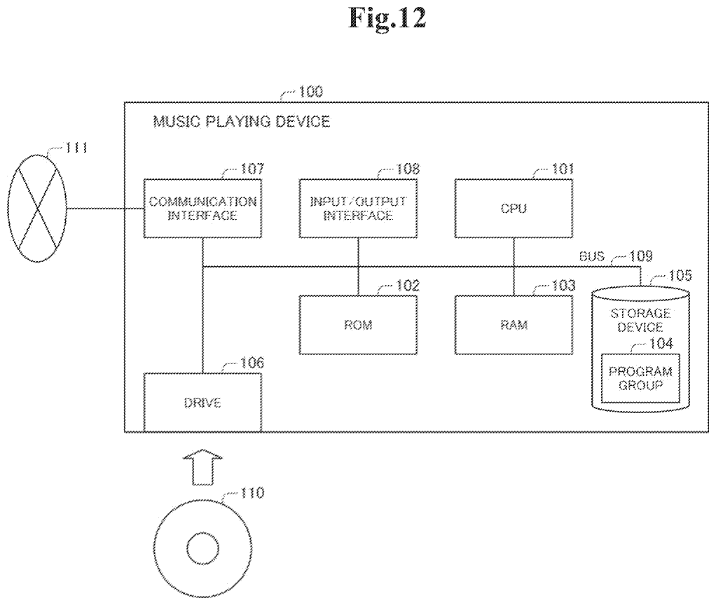

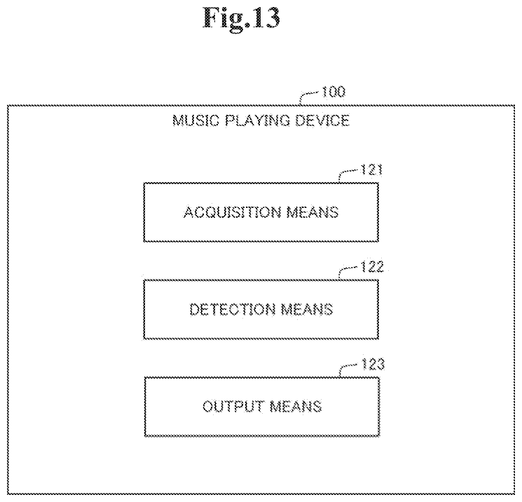

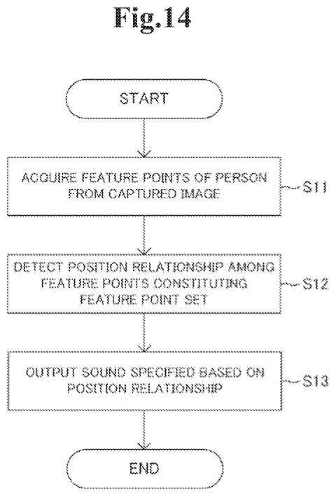

Next, a second exemplary embodiment of the present invention will be described with reference to FIGS. 12 to 14. FIGS. 12 and 13 are block diagrams illustrating configurations of a music playing device of the second exemplary embodiment, and FIG. 14 is a flowchart illustrating the operation of the music playing device. Note that the present embodiment shows the outlines of the configurations of the music playing device and the music playing method described in the first exemplary embodiment.

First, a hardware configuration of a music playing device 100 in the present embodiment will be described with reference to FIG. 12. The music playing device 100 is configured of a typical information processing device, having a hardware configuration as described below as an example
Central Processing Unit (CPU) 101 (arithmetic device)
Read Only Memory (ROM) 102 (storage device)
Random Access Memory (RAM) 103 (storage device)
Program group 104 to be loaded to the RAM 103
Storage device 105 storing therein the program group 104
Drive 106 that performs reading and writing on a storage medium 110 outside the information processing device
Communication interface 107 connecting to a communication network 111 outside the information processing device
Input/output interface 108 for performing input/output of data
Bus 109 connecting the respective constituent elements

The music playing device 100 can construct, and can be equipped with, an acquisition means 121, a detection means 122, and an output means 123 illustrated in FIG. 13 through acquisition and execution of the program group 104 by the CPU 101. Note that the program group 104 is stored in the storage device 105 or the ROM 102 in advance, and is loaded to the RAM 103 by the CPU 101 as needed. Further, the program group 104 may be provided to the CPU 101 via the communication network 111, or may be stored on the storage medium 110 in advance and read out by the drive 106 and supplied to the CPU 101. However, the acquisition means 121, the detection means 122, and the output means 123 may be constructed by dedicated electronic circuits for implementing such means.

Note that FIG. 12 illustrates an example of the hardware configuration of the information processing device that is the music playing device 100. The hardware configuration of the information processing device is not limited to that described above. For example, the information processing device may be configured of part of the configuration described above, such as without the drive 106.

The music playing device 100 executes the music playing method illustrated in the flowchart of FIG. 14, by the functions of the acquisition means 121, the detection means 122, and the output means 123 constructed by the program as described above.

As illustrated in FIG. 14, the music playing device 100 performs processing to
acquire a plurality of feature points of a person from a captured image in which the person is captured (step S11),
detect a position relationship between the plurality of feature points in a feature point set configured of a combination of the plurality of feature points (step S12), and
output a sound specified based on the detected position relationship (step S13).

With the configuration described above, the present invention can detect position relationships of a plurality of feature point sets acquired from a captured image of a person, and output a sound specified based on such position relationships. Therefore, even in the case where an operation similar to the operation of playing a musical instrument is difficult because of a physical reason for children, elderly persons, and disabled persons, it is possible to output a sound by an easy operation. As a result, in the system that allows a sound to be output without actually playing a musical instrument, the system can be used by any user, and it is possible to improve the entertainment and to use it for various purposes.

Note that the program described above can be supplied to a computer by being stored in a non-transitory computer-readable medium of any type. Non-transitory computer-readable media include tangible storage media of various types. Examples of non-transitory computer-readable media include magnetic storage media (for example, a flexible disk, a magnetic tape, and a hard disk drive), magneto-optical storage media (for example, a magneto-optical disk), a CD-ROM (Read Only Memory), a CD-R, a CD-R/W, and semiconductor memories (for example, a mask ROM, a PROM (Programmable ROM), an EPROM (Erasable PROM), a flash ROM, and a RAM (Random Access Memory)). Note that the program may be supplied to a computer by being stored in a transitory computer-readable medium of any type. Examples of transitory computer-readable media include electric signals, optical signals, and electromagnetic waves. A transitory computer-readable medium can be supplied to a computer via a wired communication channel such as a wire and an optical fiber, or a wireless communication channel.

While the present invention has been described with reference to the exemplary embodiments described above, the present invention is not limited to the above-described embodiments. The form and details of the present invention can be changed within the scope of the present invention in various manners that can be understood by those skilled in the art. Further, at least one of the functions of the acquisition means, the detection means, and the output means described above may be carried out by an information processing device provided and connected to any location on the network, that is, may be carried out by so-called cloud computing.

<Supplementary Notes>

The whole or part of the exemplary embodiments disclosed above can be described as the following supplementary notes. Hereinafter, outlines of the configurations of a music playing method, a music playing device, and a program, according to the present invention, will be described. However, the present invention is not limited to the configurations described below.

### (Supplementary Note 1)

A music playing method comprising:
acquiring a plurality of feature points of a person from a captured image in which the person is captured;
detecting a position relationship between a plurality of the feature points in a feature point set in which the plurality of feature points are combined; and
outputting a sound specified based on the detected position relationship.

### (Supplementary Note 2)

The music playing method according to supplementary note 1, further comprising
detecting the position relationship on a basis of a shape linking the plurality of feature points included in the feature point set according to a predetermined reference.

### (Supplementary Note 3)

The music playing method according to supplementary note 1 or 2, further comprising
acquiring a joint position of the person as at least one of the feature points.

### (Supplementary Note 4)

The music playing method according to any of supplementary notes 1 to 3, further comprising:
acquiring three or more feature points of the person; and
detecting the position relationship among the feature points in the feature point set in which the three or more feature points are combined.

### (Supplementary Note 5)

The music playing method according to any of supplementary notes 1 to 4, further comprising:
detecting the position relationship for each of a plurality of the feature point sets; and
outputting a sound specified based on the position relationship detected from each of the feature point sets.

### (Supplementary Note 6)

The music playing method according to supplementary note 5, further comprising
outputting a sound specified based on a combination of the position relationships respectively detected from the feature point sets.

### (Supplementary Note 7)

The music playing method according to any of supplementary notes 1 to 6, further comprising:
outputting a sound specified based on the person shown in the captured image and the position relationship detected from the person.

### (Supplementary Note 8)

The music playing method according to supplementary note 7, further comprising
outputting a sound specified based on an attribute of the person shown in the captured image and the position relationship detected from the person.

### (Supplementary Note 9)

The music playing method according to supplementary note 7 or 8, further comprising
extracting a plurality of persons from the captured image, and acquiring a plurality of the feature points from each of the persons;
detecting the position relationship for each of the persons; and
outputting a sound specified based on the position relationship detected for each of the persons.

### (Supplementary Note 10)

The music playing method according to supplementary note 9, further comprising outputting a sound of a different musical instrument for each person.

### (Supplementary Note 11)

The music playing method according to any of supplementary notes 1 to 10, further comprising
outputting, to a display device, the captured image while adding information to the captured image, the information representing the position relationship detected from the person acquired from the captured image.

### (Supplementary Note 12)

The music playing method according to any of supplementary notes 1 to 11, further comprising
outputting, to a display device, image information that is stored in advance and represents a sample of the position relationship.

### (Supplementary Note 13)

A music playing device comprising:
acquisition means for acquiring a plurality of feature points of a person from a captured image in which the person is captured;
detection means for detecting a position relationship between a plurality of the feature points in a feature point set in which the plurality of feature points are combined; and
output means for outputting a sound specified based on the detected position relationship.

### (Supplementary Note 14)

The music playing device according to supplementary note 13, wherein
the detection means detects the position relationship on a basis of a shape linking the plurality of feature points included in the feature point set according to a predetermined reference.

### (Supplementary Note 15)

The music playing device according to supplementary note 13 or 14, wherein
the acquisition means acquires a joint position of the person as at least one of the feature points.

### (Supplementary Note 16)

The music playing device according to any of supplementary notes 13 to 15, wherein
the acquisition means acquires three or more feature points of the person, and
the detection means detects the position relationship among the feature points in the feature point set in which the three or more feature points are combined.

### (Supplementary Note 17)

The music playing device according to any of supplementary notes 13 to 16, wherein
the detection means detects the position relationship for each of a plurality of the feature point sets; and
the output means outputs a sound specified based on the position relationship detected from each of the feature point sets.

### (Supplementary Note 18)

The music playing device according to supplementary note 17, wherein
the output means outputs a sound specified based on a combination of the position relationships respectively detected from the feature point sets.

### (Supplementary Note 19)

The music playing device according to any of supplementary notes 13 to 18, wherein
the output means outputs a sound specified based on the person shown in the captured image and the position relationship detected from the person.

### (Supplementary Note 20)

The music playing device according to supplementary note 19, wherein
the output means outputs a sound specified based on an attribute of the person shown in the captured image and the position relationship detected from the person.

### (Supplementary Note 21)

The music playing device according to supplementary note 19 or 20, wherein
the acquisition means extracts a plurality of persons from the captured image, and acquires a plurality of the feature points from each of the persons,
the detection means detects the position relationship for each of the persons, and
the output means outputs a sound specified based on the position relationship detected for each of the persons.

### (Supplementary Note 22)

The music playing device according to supplementary note 21, wherein
the output means outputs a sound of a different musical instrument for each person.

### (Supplementary Note 23)

The music playing device according to any of supplementary notes 13 to 22, wherein
the output means outputs, to a display device, the captured image while adding information to the captured image, the information representing the position relationship detected from the person acquired from the captured image.

### (Supplementary Note 24)

The music playing method according to any of supplementary notes 13 to 23, wherein
the output means outputs, to a display device, image information that is stored in advance and represents a sample of the position relationship.

### (Supplementary Note 25)

A computer-readable storage medium storing thereon a program for causing an information processing device to realize:
acquisition means for acquiring a plurality of feature points of a person from a captured image in which the person is captured;
detection means for detecting a position relationship between a plurality of the feature points in a feature point set in which the plurality of feature points are combined; and
output means for outputting a sound specified based on the detected position relationship.

### REFERENCE SIGNS LIST

1 camera
2 display
3 loudspeaker
10 music playing device
11 acquisition unit
12 detection unit
13 sound output unit
14 video image output unit
15 sound information storage unit
16 sample information storage unit
U, U1, U2 user
100 music playing device
101 CPU
102 ROM
103 RAM
104 program group
105 storage device
106 drive
107 communication interface
108 input/output interface
109 bus
110 storage medium
111 communication network
121 acquisition means
122 detection means
123 output means

What is claimed is:

1. A music playing method comprising:
acquiring a plurality of feature points of a person from a captured image in which the person is captured;
detecting a position relationship between a plurality of the feature points in a feature point set in which the plurality of feature points are combined; and
outputting a sound specified based on the detected position relationship.

2. The music playing method according to claim 1, further comprising
detecting the position relationship on a basis of a shape linking the plurality of feature points included in the feature point set according to a predetermined reference.

3. The music playing method according to claim 1, further comprising
acquiring a joint position of the person as at least one of the feature points.

4. The music playing method according to claim 1, further comprising:
acquiring three or more feature points of the person; and
detecting the position relationship among the feature points in the feature point set in which the three or more feature points are combined.

5. The music playing method according to claim 1, further comprising:
detecting the position relationship for each of a plurality of the feature point sets; and
outputting a sound specified based on the position relationship detected from each of the feature point sets.

6. The music playing method according to claim 5, further comprising
outputting a sound specified based on a combination of the position relationships respectively detected from the feature point sets.

7. The music playing method according to claim 1, further comprising:
outputting a sound specified based on the person shown in the captured image and the position relationship detected from the person.

8. The music playing method according to claim 7, further comprising
outputting a sound specified based on an attribute of the person shown in the captured image and the position relationship detected from the person.

9. The music playing method according to claim 7, further comprising
extracting a plurality of persons from the captured image, and acquiring a plurality of the feature points from each of the persons;
detecting the position relationship for each of the persons; and
outputting a sound specified based on the position relationship detected for each of the persons.

10. The music playing method according to claim 9, further comprising
outputting a sound of a different musical instrument for each person.

11. The music playing method according to claim 1, further comprising
outputting, to a display device, the captured image while adding information to the captured image, the information representing the position relationship detected from the person acquired from the captured image.

12. The music playing method according to claim 1, further comprising
outputting, to a display device, image information that is stored in advance and represents a sample of the position relationship.

13. An information processing device comprising:
at least one memory configured to store instructions; and
at least one processor configured to execute instructions to:
acquire a plurality of feature points of a person from a captured image in which the person is captured;
detect a position relationship between a plurality of the feature points in a feature point set in which the plurality of feature points are combined; and
output a sound specified based on the detected position relationship.

14. The information processing device according to claim 13, wherein the at least one processor is configured to execute the instructions to
detect the position relationship on a basis of a shape linking the plurality of feature points included in the feature point set according to a predetermined reference.

15. The information processing device according to claim 13, wherein the at least one processor is configured to execute the instructions to
acquire a joint position of the person as at least one of the feature points.

16. The information processing device according to claim 13, wherein the at least one processor is configured to execute the instructions to:
acquire three or more feature points of the person; and
detect the position relationship among the feature points in the feature point set in which the three or more feature points are combined.

17. The information processing device according to claim 13, wherein the at least one processor is configured to execute the instructions to:
detect the position relationship for each of a plurality of the feature point sets; and
output a sound specified based on the position relationship detected from each of the feature point sets.

18. (canceled)

19. The information processing device according to claim 13, wherein the at least one processor is configured to execute the instructions to
output a sound specified based on the person shown in the captured image and the position relationship detected from the person.

20.-22. (canceled)

23. The information processing device according to claim 13, wherein the at least one processor is configured to execute the instructions to
output, to a display device, the captured image while adding information to the captured image, the information representing the position relationship detected from the person acquired from the captured image.

24. (canceled)

25. A non-transitory computer-readable storage medium storing thereon a program comprising instructions for causing an information processing device to execute instructions to:
acquire a plurality of feature points of a person from a captured image in which the person is captured;
detect a position relationship between a plurality of the feature points in a feature point set in which the plurality of feature points are combined; and
output a sound specified based on the detected position relationship.
